(19) United States
(12) Patent Application Publication
(10) Pub. No.: US 2025/0087082 A1
(43) Pub. Date: Mar. 13, 2025

(54) DIGITAL TWINNING METHOD AND SYSTEM FOR SCENE FLOW BASED ON DYNAMIC TRAJECTORY FLOW

(71) Applicant: CHANG'AN UNIVERSITY, Shaanxi (CN)

(72) Inventors: Zhanwen LIU, Shaanxi (CN); Xing FAN, Shaanxi (CN); Shan LIN, Shaanxi (CN); Chao LI, Shaanxi (CN); Jun ZHAI, Shaanxi (CN); Yanming Fang, Shaanxi (CN); Songhua FAN, Shaanxi (CN); Zijian WANG, Shaanxi (CN); Nan YANG, Shaanxi (CN); Zhibiao XUE, Shaanxi (CN); Jin FAN, Shaanxi (CN); Juanru CHENG, Shaanxi (CN); Yuande JIANG, Shaanxi (CN); Litong ZHANG, Shaanxi (CN)

(21) Appl. No.: 18/286,540

(22) PCT Filed: Mar. 22, 2023
(86) PCT No.: PCT/CN2023/082929

§ 371 Date: Oct. 11, 2023

(30) Foreign Application Priority Data
Apr. 28, 2022 (CN) 202210461605.5

(51) Int. Cl. G08G 1/01; G06V 10/80; G06V 10/82; G06V 20/52

(52) U.S. Cl. CPC G08G 1/0129; G06V 10/806; G06V 10/82; G06V 20/52; G08G 1/0133; G08G 1/0145; G06V 2201/07

(57) ABSTRACT

Provided are a digital twinning method and system for a scene flow based on a dynamic trajectory flow, which belong to the field of traffic control. The method includes: extracting and identifying a target semantic trajectory with a detecting and tracking integrated multi-modal fusion and perception enhancement network; extracting road traffic semantics, so as to obtain a highly parameterized virtual road layout top view; obtaining a road layout traffic semantic grid encoding vector based on the virtual road layout top view; constructing a target coupling relation model; constructing a traffic force constraint model; constructing a long short term memory trajectory prediction network; predicting a motion trajectory of a target with the long short term memory trajectory prediction network, so as to obtain the predicted motion trajectory; and obtaining a digital twin of the scene flow based on trajectory extraction, semantic identification and the predicted motion trajectory.

### CROSS REFERENCE TO RELATED APPLICATION

This patent application is a national stage of International Application No. PCT/CN2023/082929, filed on Mar. 22, 2023, which claims the benefit and priority of Chinese Patent Application No. 202210461605.5 filed with the China National Intellectual Property Administration on Apr. 28, 2022 and entitled “Digital twinning method and system for scene flow based on dynamic trajectory flow”. Both of the aforementioned applications are incorporated by reference herein in their entireties as part of the present application.

### TECHNICAL FIELD

The present disclosure relates to the technical field of traffic control, and particularly relates to a digital twinning method and system for a scene flow based on a dynamic trajectory flow.

### BACKGROUND

Artificial intelligence based on deep learning architecture, an important branch in the artificial intelligence field, has been widely used in computer vision, natural language processing, sensor fusion, biometric identification, autonomous driving, etc. Global industry reference standards for automated or autonomous vehicles have been established by relevant departments to evaluate six levels (L0-L5) of an autonomous driving technology. At present, autonomous driving is restricted by factors such as laws and management policies. Although it will take some time before L4 and L5 autonomous vehicles are on the road, the L3 autonomous driving technology with restrictions (with which a driver is liberated from monitoring road conditions and a system can completely control a vehicle under special working conditions) is expected to be realized in the next five years. As an indispensable part of the L3-L5 autonomous driving technology, an advanced driving assistance system (ADAS) needs to complete various functions such as perception, fusion, planning, decision-making and early warning. Complex and changeable traffic operation conditions in a real road scene have brought many severe challenges to the autonomous driving technology based on computer vision. The traffic operation conditions include a road structure, a road width, road quality, lighting during driving, climate changes, traffic safety facilities, traffic signals, traffic markings, road traffic signs, etc.

In a highly complex traffic environment, uncertainty of objective and natural conditions brings challenges to visual perception accuracy and algorithm robustness if we only rely on widespread visual sensors.

Most of existing multi-modal information fusion methods only focus on multi-target detection in a traffic operation environment and multi-target tracking based on detectors. Obtaining high-level semantic traffic information (such as target motion trajectory information, a coupling relation, and abnormal driving behaviors) brings challenges to multi-modal information fusion perception.

Apart from real-time perception of traffic participation targets, an intelligent roadside system has to interpret traffic behaviors and scene flows within a perception boundary of the traffic operation environment with the aid of processing of edge computing resources and computing power. A macroscopic traffic situation is not enough to describe influence and state changes between vehicles in the traffic flow. Digital twinning and simulative deduction of a scene flow reflecting a meso-microscopic traffic situation are challenging.

### SUMMARY

An objective of some embodiments of the present disclosure is to provide a digital twinning method and system for a scene flow based on a dynamic trajectory flow, which can effectively achieve accurate extraction and identification of a target semantic trajectory, visualize a digital twinning of the scene flow, and provide decision support for accurate traffic control services.

To achieve the above objective, the present disclosure provides the following technical solutions.

A digital twinning method for a scene flow based on a dynamic trajectory flow is provided, which includes:
extracting and identifying a target semantic trajectory with a detecting and tracking integrated multi-modal fusion and perception enhancement network, so as to obtain trajectory extraction and semantic identification;
extracting road traffic semantics, so as to obtain a highly parameterized virtual road layout top view having a mapping relation with a real traffic scene;
obtaining a road layout traffic semantic grid encoding vector based on the virtual road layout top view;
constructing a target coupling relation model based on influence of other targets on a target in a traffic scene;
constructing a traffic force constraint model based on the target coupling relation model and a real road layout;
constructing a long short term memory trajectory prediction network based on the traffic force constraint model and the road layout traffic semantic grid encoding vector;
predicting a motion trajectory of the target with the long short term memory trajectory prediction network, so as to obtain a predicted motion trajectory; and
obtaining a digital twin of the scene flow based on a dynamic trajectory flow of areal target based on the trajectory extraction, the semantic identification and the predicted motion trajectory.

Optionally, extracting and identifying the target semantic trajectory with the detecting and tracking integrated multi-modal fusion and perception enhancement network, so as to obtain trajectory extraction and semantic identification specifically includes:
learning an invariant feature expression of different modal information with a resolution attention enhancement module,
defining a feature association tensor pool based on the invariant feature expression with a feature fusion enhancement model, and performing feature fusion on all modal convolution output tensors, so as to obtain fused features;
inputting the fused features into a main three-dimensional (3D) parameter sharing convolution network, so as to obtain different features;
inputting the different features into a motion inference subnet, and tracking a target trajectory, so as to obtain the trajectory extraction; and
inputting the different features into a driving behavior identification subnet to identify a driving behavior, and inputting the different features into an occlusion identification subnet to identify a target occlusion part, so as to obtain the semantic identification.

Optionally, extracting the road traffic semantics, so as to obtain the highly parameterized virtual road layout top view having the mapping relation with the real traffic scene specifically includes:
coupling a road topological structure in the traffic scene with a traffic participation target motion trajectory, so as to obtain a road layout traffic semantic height parameters;
constructing a virtual road layout top view extraction cascade network based on the road layout traffic semantic height parameter; and
obtaining the highly parameterized virtual road layout top view based on a pixel space mapping relation between a real traffic scene image and the virtual road layout top view extraction cascade network.

Optionally, coupling the road topological structure in the traffic scene with the traffic participation target motion trajectory, so as to obtain the road layout traffic semantic height parameter specifically includes:
obtaining topological attributes, road layout attributes, traffic sign attributes, and pedestrian area attributes, where the topological attributes include: start point and end point positions of a main road, and a distance, a line shape and a crossing relation of an auxiliary road in the traffic scene; the road layout attributes include: a number of lanes, widths of lanes and information indicating whether a lane is a one-way lane; the traffic sign attributes include: a lane speed limit value and a lane line shape; and the pedestrian area attributes include: a width of a crosswalk and a width of a walkway; and
assigning unique identities (IDs) to the topological attributes, the road layout attributes, the traffic sign attributes and the pedestrian area attributes respectively, so as to obtain road layout traffic semantics parameterization;
constructing the virtual road layout top view extraction cascade network based on the road layout traffic semantic height parameters specifically includes:
collecting red-green-blue (RGB) images of road traffic, and extracting the RGB images of the road traffic with a semantic segmentation network, so as to obtain a real road semantic top view;
sampling a simulated road image with complete annotation based on a simulator, so as to obtain a simulated road top view;
extracting features of the road semantic top view and the simulated road top view respectively, so as to a virtual-real adversarial loss function based on virtual-real combination mixed training; and
iterating the virtual-real adversarial loss function to bridge a gap between the simulated road top view and the real road semantic top view; where
the virtual-real adversarial loss function is:

$${L}_{sup} = {λ}^{r} \cdot {L}_{sup}^{r} + λ \text{?} \cdot {L}_{sup}^{s} \qquad ( 1 )$$

$$\text{?} \text{indicates text missing or illegible when filed}$$

where Lₛᵤₚ^{r} denotes a loss function under supervision of real data, Lₛᵤₚ^{x} denotes a loss function under supervision of simulated data, λ^{r} denotes an importance weight of real data, and λ^{s} denotes an importance weight of simulated data.

Optionally, obtaining the highly parameterized virtual road layout top view on based on the pixel space mapping relation between the real traffic scene image and the virtual road layout top view extraction cascade network specifically includes:
encoding a historical target trajectory in the real traffic scene into the virtual road layout top view with a grid encoding algorithm, so as to obtain a virtual coordinate trajectory and corresponding road layout parameters; and
integrating the virtual coordinate trajectory and the corresponding road layout parameters, so as to obtain the road layout traffic semantic grid encoding vector, where
the historical target trajectory in the real traffic scene is the trajectory extraction and the semantic identification.

Optionally, constructing the target coupling relation model based on the influence of other targets on the target in the traffic scene specifically includes:
establishing interaction forces between targets based on a radial kernel function, establishing influence weights between targets based on target types and distances between targets, and constructing the target coupling relation model by weighting and summing the interaction forces between targets, and coupling relations between targets, where
the target coupling relation model is Φₜⁱ, and at moment t, the influence of other targets on the target i in the traffic scene is as follows:

$${ϕ}_{t}^{i} {\sum }_{j = 1 , j = i}^{j = n ( t )} {w}_{i j}^{t} {f}_{i j}^{t} \qquad ( 2 )$$

where fᵢⱼ^{t} denotes interaction between targets i and j at the moment t; wᵢⱼ^{t} denotes a weight vector, which is configured to express a difference of interaction between different moving targets; and n(t) denotes a number of targets in the traffic scene at the moment t.

Optionally, constructing the traffic force constraint model based on the target coupling relation model and the real road layout specifically includes:
defining a traffic force as a joint interaction force formed on the target by the coupling relation between targets and the real road layout, and defining the traffic force Fₜⁱ received by the target i at the moment t as:

$${F}_{t}^{i} = connect ( {ϕ}_{t}^{i} , E ( {c}_{i} {e}_{t}^{i} ) ) \qquad ( 3 )$$

where Φₜⁱ denotes the coupling relation between targets; eₜⁱ denotes encoding information of layout semantics of a road where the target i is located at the moment t; cᵢ denotes a moving target type given by a behavior identification subnet, which is configured to express a difference of influence of the same road layout on different types of targets; and mapping E is configured to give an interaction force of the road layout on the target i based on the target type and the road layout semantic information.

Optionally, constructing the long short term memory trajectory prediction network based on the traffic force constraint model and the road layout traffic semantic grid encoding vector specifically includes:
obtaining influence of other targets on a predicted target in the traffic scene based on the interaction forces between targets and the influence weights between targets;
obtaining an interaction force of the road layout on the predicted target through mapping according to a moving target type and the road layout semantic encoding information given by the virtual road layout top view;
merging the influence of other traffic targets on the predicted target with the interaction force of the road layout on the predicted target, so as to obtain a traffic force on the predicted target; and
merging a historical motion state of the predicted target with the traffic force, and accessing a long short term memory (LSTM) network for time series modeling, so as to obtain the long short term memory trajectory prediction network.

Optionally, obtaining the digital twin of the scene flow based on the dynamic trajectory flow of the real target based on the trajectory extraction, the semantic identification and the predicted motion trajectory specifically includes:
restoring the target historical trajectory in the real traffic scene and the predicted motion trajectory to a virtual entity of an actual traffic operation environment, modeling a time series evolution rule of a mesoscopic traffic situation, visualizing a three-dimensional traffic situation map evolution process, and obtaining the digital twin of the scene flow based on the dynamic trajectory flow of the real target;
modeling the time series evolution rule specifically includes: constructing a time series evolution rule model according to a trajectory, a speed and the traffic force constraint model as follows:

$${θ}_{t} = ( {p}_{t}^{1} , {v}_{t}^{1} , {F}_{t}^{1} , {p}_{t}^{2} , {v}_{t}^{2} , {F}_{t}^{2} , … , {p}_{t}^{n ( t ) 1} , {v}_{t}^{n ( t )} , {F}_{t}^{n ( t )} ) \qquad ( 4 )$$

where pₜⁱ and vₜⁱ, denote a position and a speed of the target i at the moment t, respectively, vₜⁱ is calculated from positions of the target in two frames and inter-frame space, and Fₜⁱ denotes the traffic force constraint model; and
the virtual entity is a three-dimensional model of a road scene generated by importing the highly parameterized virtual road layout top view into a three-dimensional simulation tool.

To achieve the above objective, the present disclosure further provides the following technical solution.

A digital twinning system for a scene flow based on a dynamic trajectory flow is provided, which includes:
a first construction module configured to construct a detecting and tracking integrated multi-modal fusion and perception enhancement network to extract and identify a target semantic trajectory, so as to obtain trajectory extraction and semantic identification;
an extraction module configured to extract road traffic semantics, so as to obtain a highly parameterized virtual road layout top view having a mapping relation with a real traffic scene;
an obtaining module configured to obtain a road layout traffic semantic grid encoding vector based on the virtual road layout top view;
a second construction module configured to construct a target coupling relation model based on influence of other targets on a target in a traffic scene;
a third construction module configured to construct a traffic force constraint model based on the target coupling relation model and a real road layout;
a trajectory prediction network construction module configured to construct a long short term memory trajectory prediction network based on the traffic force constraint model and the road layout traffic semantic grid encoding vector;
a prediction module configured to predict a motion trajectory of the target with the long short term memory trajectory prediction network, so as to obtain a predicted motion trajectory; and
a digital twinning module configured to obtain a digital twin of the scene flow based on a dynamic trajectory flow of a real target based on the trajectory extraction, the semantic identification and the predicted motion trajectory.

According to specific embodiments provided by the present disclosure, the present disclosure provides the following technical effects.

In the present disclosure, a detecting and tracking integrated multi-modal fusion and perception enhancement network is provided, and a target historical trajectory in a real traffic scene is obtained, such that all modal convolution output tensors can be effectively fused, and features of all dimensions of a target in the real traffic scene are extracted separately. Accurate extraction and identification of a target semantic trajectory are achieved. In addition, a motion trajectory of the target is predicted based on a long short term memory trajectory prediction network, a time series evolution rule of a mesoscopic traffic situation is modeled according to trajectory extraction, semantic identification and the predicted motion trajectory, and a digital twin of the scene flow based on a dynamic trajectory flow of a real target is obtained, such that the decision support for the accurate traffic control services is provided.

### BRIEF DESCRIPTION OF THE DRAWINGS

To describe technical solutions in embodiments of the present disclosure or in the prior art more clearly, the accompanying drawings required in the embodiments are briefly introduced below. Apparently, the accompanying drawings described below are only some embodiments of the present disclosure. Those of ordinary skill in the art can also obtain other accompanying drawings according to these accompanying drawings without creative efforts.

FIG. 1 is a flow diagram of a digital twinning method for a scene flow based on a dynamic trajectory flow according to the present disclosure;

FIG. 2 is a structural diagram of a digital twinning method for a scene flow based on a dynamic trajectory flow according to the present disclosure;

FIG. 3 is a structural diagram of a detecting and tracking integrated multi-modal fusion and perception enhancement network according to the present disclosure:

FIG. 4 is a structural diagram of a prediction network based on long short term memory trajectory according to the present disclosure;

FIG. 5 is a structural diagram of a parameterized road layout top view extraction network according to the present disclosure; and

FIG. 6 is a structural diagram of a digital twinning system for a scene flow based on a dynamic trajectory flow according to the present disclosure.

### DETAILED DESCRIPTION OF THE EMBODIMENTS

Technical solutions of embodiments of the present disclosure will be clearly and completely described below with reference to the accompanying drawings in the embodiments of the present disclosure. Apparently, the described embodiments are merely some embodiments rather than all embodiments of the present disclosure. All other embodiments obtained by those of ordinary skill in the art based on the embodiments of the present disclosure without creative efforts shall fall within the protection scope of the present disclosure.

An objective of some embodiments of the present disclosure is to provide a digital twinning method and system for a scene flow based on a dynamic trajectory flow, which can effectively achieve accurate extraction and identification of a target semantic trajectory, visualize a digital twinning of the scene flow, and provide decision support for accurate traffic control services.

To make the above objectives, features, and advantages of the present disclosure clearer and more comprehensible, the present disclosure will be further described in detail below with reference to the accompanying drawings and specific implementations.

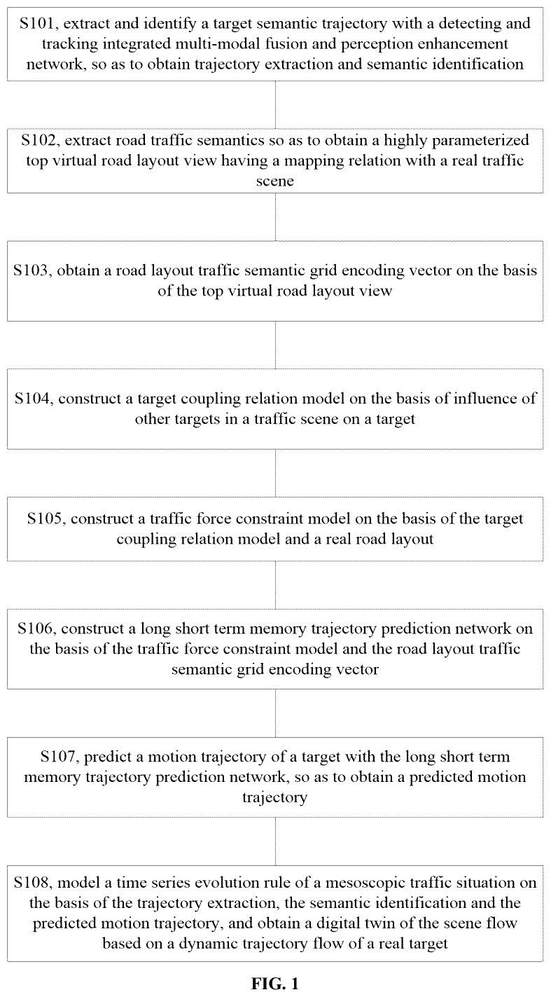

As shown in FIG. 1, the present disclosure provides a digital twinning method for a scene flow based on a dynamic trajectory flow. The method includes steps S101-S108.

In S101, a target semantic trajectory is extracted and identified by a detecting and tracking integrated multi-modal fusion and perception enhancement network, so as to obtain trajectory extraction and semantic identification.

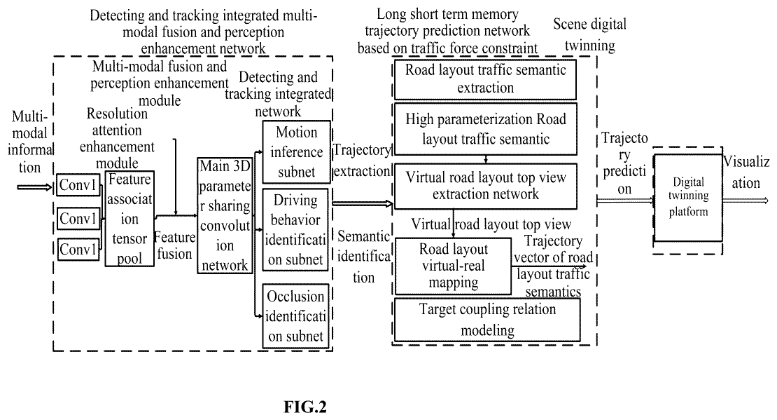

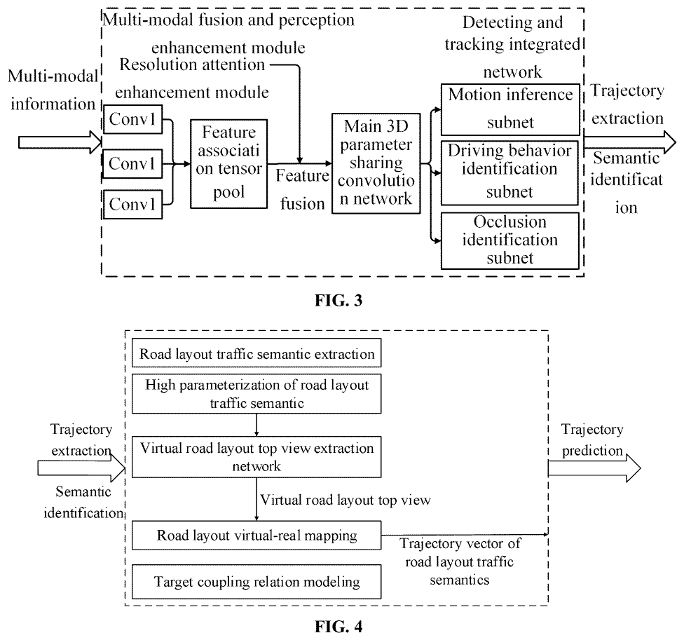

As shown in FIGS. 2, 3 and 4, the detecting and tracking integrated multi-modal fusion and perception enhancement network includes a multi-modal fusion and perception enhancement module and a detecting and tracking integrated network. The multi-modal fusion and perception enhancement module includes a resolution attention enhancement module and a feature fusion enhancement model.

The resolution attention enhancement module is configured to learn an invariant feature expression of different modal information.

The feature fusion enhancement model defines a feature association tensor pool according the invariant feature expression, feature fusion is performed on all modal convolution output tensors gathered in the tensor pool, and the fused features are output as input of a main network.

The detecting and tracking integrated network includes the main network and three sub-networks. The main network is a main three-dimensional (3D) parameter sharing convolution network. The main 3D parameter sharing convolution network is used as a feature extractor which is configured to extract different features and transmit the features into the three sub-networks.

The three sub-networks are a motion inference subnet, a driving behavior identification subnet and an occlusion identification subnet, respectively. The motion inference subnet is configured to track an object trajectory to obtain trajectory extraction. The driving behavior identification subnet is configured to identify a driving behavior. The occlusion identification subnet is configured to identify a target occlusion part to obtain semantic identification.

A resolution attention enhancement module is constructed in a convolution block of the detecting and tracking integrated network, such that attribute features of different modal spaces are extracted, and the invariant feature expression of different modal information is learned through adaptive weight assignment. In addition, multi-layer attention features are cascaded through residual connection, and different layer features are adaptively selected and finally more accurate context information may be obtained, such that overall performance of the network may be improved.

A feature fusion enhancement model is constructed based on different modal convolution feature map groups of spatial attention. The feature association tensor pool is defined, such that multi-modal convolution outputs are gathered in the tensor pool for fusion. The outputs are used as inputs of convolution layers corresponding to the three subnets, such that accurate trajectory extraction and identification are obtained.

Since an evaluation result of a mainstream tracking model is greatly influenced by a detecting result, the present disclosure provides a multi-modal fusion detecting and tracking integrated end-to-end network, which may detect a target object implicitly in a tracker, and also eliminate influence of bias and errors of previous detector on the tracking network. The multi-modal fusion detecting and tracking integrated end-to-end network includes a 3D parameter sharing convolution main network and three sub-networks with different task functions. Object trajectory tracking, driving behavior identification and target occlusion identification are performed under the three sub-networks, respectively. Firstly, the 3D parameter sharing convolution main network is used as a feature extractor to process a normal form (NF) frame video and a two dimensional (2D) image mapped by an NF frame radar point cloud separately. Secondly, features of six middle layers in the network are fused and transmitted to the three sub-networks, respectively.

In the motion inference subnet, a 3D convolutional neural network with multi-modal fusion features as inputs is constructed, and target features of an NF frame and an inter-frame target motion correlation are synchronously extracted layer by layer.

In the driving behavior identification subnet, a 3D convolutional neural network with multi-modal fusion features as inputs is constructed, a mapping relation between the network and the driving behavior is mined layer by layer, and multi-modal space-time feature mathematical expressions of normal driving behaviors and abnormal driving behaviors (such as swing, tilt, sideslip, quick U-turn, large-radius turn and sudden braking) are defined. By using various layer-by-layer multi-modal convolution fusion features, and considering motion trajectory characteristics of a motion subnet and an optimized mapping function, a more accurate classification model of abnormal driving behaviors may be learned.

In the occlusion identification subnet, whether each anchor pipe is occluded at any moment t is determined through computation. If the anchor pipe is occluded, it means that the target cannot be detected and tracked, that is, the target is filtered out in a non-maximum suppression stage. If the anchor pipe is not occluded, it is selected and compared with a true value, and then given a true value tag to participate in training, such that tracking accuracy and robustness of the entire network are improved.

In S102, road traffic semantics are extracted to obtain a highly parameterized virtual road layout top view having a mapping relation with a real traffic scene.

Road layout traffic semantic height parameters are obtained based on a coupling relation between a road topological structure in the traffic scene and a traffic participation target motion trajectory.

A parameterized virtual road layout top view extraction cascade network of a real scene is constructed. The virtual road layout top view extraction cascade network is constructed according to a virtual-real combination mixed training parameter and based on the road layout traffic semantic height parameters.

Based on a pixel space mapping relation between a real traffic scene image and the trained virtual road layout top view extraction cascade network, virtual-real mapping of road layout is constructed. The highly parameterized virtual road layout top view having a mapping relation with the real traffic scene is obtained.

The road topological structure in the traffic scene is coupled with the traffic participation target motion trajectory, so as to obtain the road layout traffic semantic height parameter as follows:

Topological attributes, road layout attributes, traffic sign attributes and pedestrian area attributes are obtained. The topological attributes include: start point and end point positions of a main road, and a distance, a line shape and a crossing relation of an auxiliary road in the traffic scene. The road layout attributes include: a number of lanes, a width of the lanes and information indicating whether a lane is a one-way lane. The traffic sign attributes include: a lane speed limit value and a lane line shape. The pedestrian area attributes include: a width of a crosswalk and a width of a walkway.

Unique IDs are assigned to the topological attributes, the road layout attributes, the traffic sign attributes and the pedestrian zone attributes separately, so as to obtain road layout traffic semantic parameterization.

High parameterization of road layout traffic semantic is provided. The coupling relation between the road topological structure in the traffic scene and the traffic participation target motion trajectory is studied, and the start point and end point positions of the main road and road crossing relations such as the distance, the line shape and the position of the auxiliary road in the traffic scene are defined, such that flexibility of three-way or four-way intersection modeling may be improved advantageously. Function and semantic expressions of refined road parameters and universal traffic rules in road layout reasoning of traffic scenes are studied, single road layout attributes such as the number of lanes, the width of the lanes and the information indicating whether a lane is a one-way lane are defined, the traffic sign attributes such as the lane speed limit value and the lane line shape are defined, and scene elements of pedestrian behavior constraints such as crosswalks, walkways and widths are defined, and a parameter list is established, such that constraints of vehicle driving behaviors and trajectory reasoning and prediction are clarified advantageously. Structural characteristics of complex traffic scenes and functions of a refined road layout and universal traffic rules in macro traffic scene layout reasoning are studied, and a plurality of traffic attributes are defined. The traffic attributes are divided into four categories: topological attributes of a road macro-structure, lane-level attributes of a refined road layout, pedestrian area attributes for restricting traffic participant behaviors and traffic sign attributes. With real traffic scenes as examples, definitions of key attributes in each category are explained.

The virtual road layout top view extraction cascade network is constructed based on the road layout traffic semantic height parameters as follows:

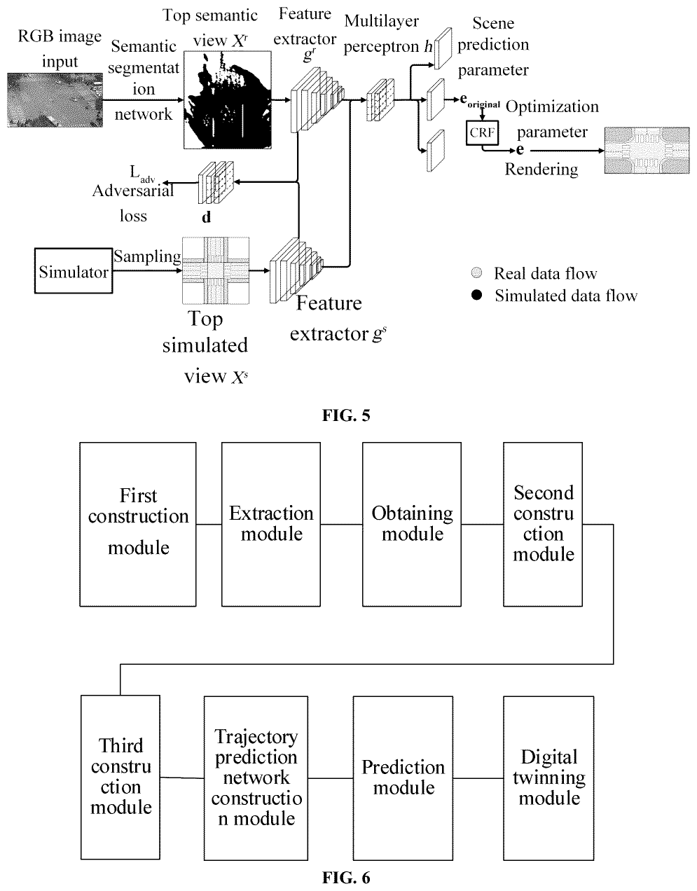

As shown in FIG. 5, red-green-blue (RGB) images of road traffic are collected, and the RGB images of road traffic are extracted by a semantic segmentation network, so as to obtain a real road semantic top view.

The simulated road image with complete annotation is sampled based on a simulator, so as to obtain a simulated road top view.

Features of the real road semantic top view and the simulated road top view are extracted respectively, and a virtual-real adversarial loss function is established based on virtual-real combination mixed training.

The virtual-real adversarial loss function is iterated to bridge a gap between the simulated road top view and the real road semantic top view.

The virtual-real adversarial loss function is:

$${L}_{sup} = {λ}^{r} \cdot {L}_{sup}^{r} + {λ}^{s} \cdot {L}_{sup}^{s} \qquad ( 1 )$$

Lₛᵤₚ^{r} denotes a loss function under supervision of real data, Lₛᵤₚ^{s} denotes a loss function under supervision of simulated data, λ^{r} denotes an importance weight of real data, and λ^{s} denotes an importance weight of simulated data.

A highly parameterized road layout top view extraction network based on virtual-real combination mixed training is provided. The traffic scene is understood, and road layout scene parameters and a simulated top view are predicted based on real RGB images. Firstly, the network uses two information sources as inputs, which include a large number of simulated road top views with complete annotation and a small number of actually collected real traffic scene images with incomplete manual annotation and noise. A semantic top view of a real image is obtained with an existing semantic segmentation network, and a data set of corresponding scene attributes is obtained based on definitions of road layout traffic semantic parameters. Secondly, a mapping relation between a top view and scene parameters is constructed and defined. Finally, with video data as input, a conditional random field (CRF) is used to improve temporal smoothness based on a scene prediction parameter vector.

The highly parameterized virtual road layout top view is obtained based on the pixel space mapping relation between the real traffic scene image and the virtual road layout top view extraction cascade network as follows.

A target historical trajectory in the real traffic scene provided by the detecting and tracking integrated network is encoded into the virtual road layout top view with a multi-scale adaptive search grid encoding algorithm, so as to obtain a virtual coordinate trajectory and corresponding road layout parameters. The virtual coordinate trajectory and the corresponding road layout parameters are integrated, so as to obtain the road layout traffic semantic grid encoding vector.

The historical target trajectory in the real traffic scene provided by the detecting and tracking integrated network is the obtained trajectory extraction and the semantic identification.

In S103, the road layout traffic semantic grid encoding vector is obtained based on the virtual road layout top view.

In S104, a target coupling relation model is constructed based on influence of other targets on a target in a traffic scene.

An influence mechanism of positional relations and interaction between different targets is studied, the interaction between different targets is expressed by a radial kernel function, and strength of interaction between multiple targets is described qualitatively and quantitatively.

Interaction forces between targets are established based on the radial kernel function, influence weights between targets is established based on target types and distances between targets, and the target coupling relation model is constructed by weighting and summing the interaction forces between targets, and coupling the relations between targets.

The target coupling relation model is Φₜⁱ. At moment t, influence of other targets on a target i in the traffic scene is as follows:

$${ϕ}_{t}^{i} {\sum }_{j = 1 , j = i}^{j = n ( t )} {w}_{i j}^{t} {f}_{i j}^{t} \qquad ( 2 )$$

fᵢⱼ^{t} denotes an interaction between targets i and j at the moment t. wᵢⱼ^{t} denotes a weight vector, which is configured to express a difference of interaction between different moving targets. n(t) denotes a number of targets in the traffic scene at the moment t.

In S105, a traffic force constraint model is constructed based on the target coupling relation model and the real road layout.

A traffic force is a joint interaction force formed on targets by coupling relations between targets and the real road layout. The traffic force Fₜⁱ received by the target i at the moment t is defined as.

$${F}_{t}^{i} = connect ( {ϕ}_{t}^{i} , E ( {c}_{i} {e}_{t}^{i} ) ) \qquad ( 3 )$$

Φₜⁱ denotes the coupling relation between targets. eₜⁱ denotes encoding information of layout semantics of a road where the target i is located at the moment t. cᵢ denotes a moving target type given by a behavior identification subnet, which is configured to express a difference of influence of the same road layout on different types of targets. Mapping E is configured to give an interaction force of the road layout on the target i based on the target type and road layout semantic information.

In S106, a long short term memory trajectory prediction network is constructed based on the traffic force constraint model and the road layout traffic semantic grid encoding vector.

Influence of other targets on a predicted target in the traffic scene is obtained based on the interaction forces between targets and the influence weights between targets.

An interaction force of the road layout on the predicted target is obtained through mapping according to the moving target type and the road layout semantic encoding information given by the virtual road layout top view.

Influence of other traffic targets on the predicted target is merged with the interaction force of the road layout on the predicted target, so as to obtain a traffic force of the predicted target.

A historical motion state of the predicted target is merged with all traffic forces, and a long short term memory (LSTM) network is accessed for time series modeling, so as to obtain the long short term memory trajectory prediction network.

In S107, a motion trajectory of the target is predicted with the long short term memory trajectory prediction network, so as to obtain a predicted motion trajectory.

In S108, a time series evolution rule of a mesoscopic traffic situation is modeled based on the trajectory extraction, the semantic identification and the predicted motion trajectory, so as to obtain a digital twin of a scene flow based on a dynamic trajectory flow of a real target.

The historical target trajectory in the real traffic scene and the predicted motion trajectory are restored to a virtual entity of an actual traffic operation environment, the time series evolution rule of the mesoscopic traffic situation is modeled, a three-dimensional traffic situation map evolution process is visualized, and the digital twin of the scene flow based on the dynamic trajectory flow of the real target is obtained.

The time series evolution rule is modeled as follows: The time series evolution rule model is constructed according to a trajectory, a speed and the traffic force constraint model as follows:

$${θ}_{t} = ( {p}_{t}^{1} , {v}_{t}^{1} , {F}_{t}^{1} , {p}_{t}^{2} , {v}_{t}^{2} , {F}_{t}^{2} , … , {p}_{t}^{n ( t ) 1} , {v}_{t}^{n ( t )} , {F}_{t}^{n ( t )} ) \qquad ( 4 )$$

pₜⁱ and vₜⁱ denote a position and a speed of the target i at the moment t, respectively. vₜⁱ may be calculated from positions of the target in two frames and a inter-frame space. Fₜⁱ denotes the traffic force constraint model.

The virtual entity is a three-dimensional model of a road scene generated by importing a highly parameterized simulated road layout top view into a three-dimensional simulation tool.

As shown in FIG. 6, the present disclosure provides a digital twinning system for a scene flow based on a dynamic trajectory flow. The system includes:
a first construction module configured to construct a detecting and tracking integrated multi-modal fusion and perception enhancement network to extract and identify a target semantic trajectory, so as to obtain trajectory extraction and semantic identification;
an extraction module configured to extract road traffic semantics so as to obtain a highly parameterized virtual road layout top view having a mapping relation with a real traffic scene;
an obtaining module configured to obtain a road layout traffic semantic grid encoding vector based on the virtual road layout top view;
a second construction module configured to construct a target coupling relation model based on influence of other targets on a target in a traffic scene;
a third construction module configured to construct a traffic force constraint model based on the target coupling relation model and the real road layout;
a trajectory prediction network construction module configured to construct a long short term memory trajectory prediction network based on the traffic force constraint model and the road layout traffic semantic grid encoding vector;
a prediction module configured to predict a motion trajectory of the target with the long short term memory trajectory prediction network, so as to obtain a predicted motion trajectory; and
a digital twinning module configured to model a time series evolution rule of a mesoscopic traffic situation based on the trajectory extraction, the semantic identification and the predicted motion trajectory, so as to obtain a digital twin of a scene flow based on a dynamic trajectory flow of a real target.

Embodiments of the description are described in a progressive manner, each embodiment focuses on the difference from the other embodiments, and the same and similar parts between the embodiments may refer to each other.

Specific examples are used herein to explain principles and implementations of the present disclosure. The above description of the embodiments is used to help understand the method of the present disclosure and its core ideas. Besides, those of ordinary skill in the art can make various modifications to specific implementations and the application scope in accordance with the ideas of the present disclosure. In conclusion, the content of the description shall not be construed as a limitation to the present disclosure.

What is claimed is:

1. A digital twinning method for a scene flow based on a dynamic trajectory flow, comprising:
extracting and identifying a target semantic trajectory with a detecting and tracking integrated multi-modal fusion and perception enhancement network, so as to obtain trajectory extraction and semantic identification;
extracting road traffic semantics, so as to obtain a highly parameterized virtual road layout top view having a mapping relation with a real traffic scene;
obtaining a road layout traffic semantic grid encoding vector based on the virtual road layout top view;
constructing a target coupling relation model based on influence of other targets on a target in a traffic scene;
constructing a traffic force constraint model based on the target coupling relation model and a real road layout;
constructing a long short term memory trajectory prediction network based on the traffic force constraint model and the road layout traffic semantic grid encoding vector;
predicting a motion trajectory of the target with the long short term memory trajectory prediction network, so as to obtain a predicted motion trajectory; and
obtaining a digital twin of the scene flow based on a dynamic trajectory flow of a real target based on the trajectory extraction, the semantic identification and the predicted motion trajectory.

2. The method according to claim 1, wherein extracting and identifying the target semantic trajectory with the detecting and tracking integrated multi-modal fusion and perception enhancement network, so as to obtain trajectory extraction and semantic identification comprises:
learning an invariant feature expression of different modal information with a resolution attention enhancement module;
defining a feature association tensor pool with a feature fusion enhancement model based on the invariant feature expression, and performing feature fusion on all modal convolution output tensors, so as to obtain fused features;
inputting the fused features into a main three-dimensional (3D) parameter sharing convolution network, so as to obtain different features;
inputting the different features into a motion inference subnet, and tracking a target trajectory, so as to obtain the trajectory extraction; and
inputting the different features into a driving behavior identification subnet to identify a driving behavior, and inputting the different features into an occlusion identification subnet to identify a target occlusion part, so as to obtain the semantic identification.

3. The method according to claim 1, wherein extracting the road traffic semantics, so as to obtain the highly parameterized virtual road layout top view having the mapping relation with the real traffic scene comprises:
coupling a road topological structure in the traffic scene with a traffic participation target motion trajectory, so as to obtain road layout traffic semantic height parameters;
constructing a virtual road layout top view extraction cascade network based on the road layout traffic semantic height parameters; and
obtaining the highly parameterized virtual road layout top view based on a pixel space mapping relation between a real traffic scene image and the virtual road layout top view extraction cascade network.

4. The method according to claim 3, wherein coupling the road topological structure in the traffic scene with the traffic participation target motion trajectory, so as to obtain the road layout traffic semantic height parameters comprises:
obtaining topological attributes, road layout attributes, traffic sign attributes, and pedestrian area attributes, wherein the topological attributes comprise: start point and end point positions of a main road, and a distance, a line shape and a crossing relation of an auxiliary road in the traffic scene; the road layout attributes comprise: a number of lanes, widths of lanes and information indicating whether a lane is a one-way lane; the traffic sign attributes comprise: a lane speed limit value and a lane line shape; and the pedestrian area attributes comprise: a width of a crosswalk and a width of a walkway; and
assigning unique identities (IDs) to the topological attributes, the road layout attributes, the traffic sign attributes and the pedestrian area attributes respectively, so as to obtain road layout traffic semantics parameterization;
constructing the virtual road layout top view extraction cascade network based on the road layout traffic semantic height parameters comprises:
collecting red-green-blue (RGB) images of road traffic, and extracting the RGB images of the road traffic with a semantic segmentation network, so as to obtain a real road semantic top view;
sampling a simulated road image with complete annotation based on a simulator, so as to obtain a simulated road top view;
extracting features of the real road semantic top view and the simulated road top view respectively, so as to obtain a virtual-real adversarial loss function based on virtual-real combination mixed training; and
iterating the virtual-real adversarial loss function to bridge a gap between the simulated road top view and the real road semantic top view, wherein
the virtual-real adversarial loss function is:
$${L}_{sup} = {λ}^{r} \cdot {L}_{sup}^{r} + λ \text{?} \cdot {L}_{sup}^{s} \qquad ( 1 )$$
$$\text{?} \text{indicates text missing or illegible when filed}$$
where Lₛᵤₚ^{r} denotes a loss function under supervision of real data, Lₛᵤₚ^{s} denotes a loss function under supervision of simulated data, λ^{r} denotes an importance weight of real data, and λ^{s} denotes an importance weight of simulated data.

5. The method according to claim 4, wherein obtaining the highly parameterized virtual road layout top view based on the pixel space mapping relation between the real traffic scene image and the virtual road layout top view extraction cascade network comprises:
encoding a historical target trajectory in the real traffic scene into the virtual road layout top view with a grid encoding algorithm, so as to obtain a virtual coordinate trajectory and corresponding road layout parameters; and
integrating the virtual coordinate trajectory and the corresponding road layout parameters, so as to obtain the road layout traffic semantic grid encoding vector, wherein
the historical target trajectory in the real traffic scene is the trajectory extraction and the semantic identification.

6. The method according to claim 5, wherein constructing the target coupling relation model based on the influence of other targets on the target in the traffic scene comprises:
establishing interaction forces between targets based on a radial kernel function, establishing influence weights between targets based on target types and distances between targets, and constructing the target coupling relation model by weighting and summing the interaction forces between targets, and coupling relations between targets,
wherein the target coupling relation model is Φₜⁱ, and at moment t, the influence of other targets on the target i in the traffic scene is as follows:
$${ϕ}_{t}^{i} {\sum }_{j = 1 , j = i}^{j = n ( t )} {w}_{i j}^{t} {f}_{i j}^{t} \qquad ( 2 )$$
where fᵢⱼ^{t} denotes interaction between targets i and j at the moment t; wᵢⱼ^{t} denotes a weight vector, which is configured to express a difference of interaction between different moving targets; and n(t) denotes a number of targets in the traffic scene at the moment t.

7. The method according to claim 6, wherein constructing the traffic force constraint model based on the target coupling relation model and the real road layout comprises:
defining a traffic force as a joint interaction force formed on the target by the coupling relation between targets and the real road layout, and defining the traffic force Fₜⁱ received by the target i at the moment t as:
$${F}_{t}^{i} = connect ( {ϕ}_{t}^{i} , E ( {c}_{i} {e}_{t}^{i} ) ) \qquad ( 3 )$$
where Φₜⁱ denotes the coupling relation between targets; eₜⁱ denotes encoding information of layout semantics of a road where the target i is located at the moment t; cᵢ denotes a moving target type given by a behavior identification subnet, which is configured to express a difference of influence of the same road layout on different types of targets; and mapping E is configured to give an interaction force of the road layout on the target i based on the target type and the road layout semantic information.

8. The method according to claim 7, wherein constructing the long short term memory trajectory prediction network based on the traffic force constraint model and the road layout traffic semantic grid encoding vector comprises:
obtaining influence of other targets on a predicted target in the traffic scene based on the interaction forces between targets and the influence weights between targets;
obtaining an interaction force of the road layout on the predicted target through mapping according to a moving target type and the road layout semantic encoding information given by the virtual road layout top view;
merging the influence of other traffic targets on the predicted target with the interaction force of the road layout on the predicted target, so as to obtain a traffic force on the predicted target; and
merging a historical motion state of the predicted target with the traffic force, and accessing a long short term memory (LSTM) network for time series modeling, so as to obtain the long short term memory trajectory prediction network.

9. The method according to claim 8, wherein obtaining the digital twin of the scene flow based on the dynamic trajectory flow of the real target based on the trajectory extraction, the semantic identification and the predicted motion trajectory comprises:
restoring the target historical trajectory in the real traffic scene and the predicted motion trajectory to a virtual entity of an actual traffic operation environment, modeling a time series evolution rule of a mesoscopic traffic situation, visualizing a three-dimensional traffic situation map evolution process, and obtaining the digital twin of the scene flow based on the dynamic trajectory flow of the real target;
wherein modeling the time series evolution rule comprises: constructing a time series evolution rule model according to a trajectory, a speed and the traffic force constraint model as follows:
$${θ}_{t} = ( {p}_{t}^{1} , {v}_{t}^{1} , {F}_{t}^{1} , {p}_{t}^{2} , {v}_{t}^{2} , {F}_{t}^{2} , … , {p}_{t}^{n ( t ) 1} , {v}_{t}^{n ( t )} , {F}_{t}^{n ( t )} ) \qquad ( 4 )$$
where pₜⁱ and vₜⁱ denote a position and a speed of the target i at the moment t, respectively, vₜⁱ is calculated from positions of the target in two frames and inter-frame space, and Fₜⁱ denotes the traffic force constraint model; and
wherein the virtual entity is a three-dimensional model of a road scene generated by importing the highly parameterized virtual road layout top view into a three-dimensional simulation tool.

10. A digital twinning system for a scene flow based on a dynamic trajectory flow, comprising:
a first construction module configured to construct a detecting and tracking integrated multi-modal fusion and perception enhancement network to extract and identify a target semantic trajectory, so as to obtain trajectory extraction and semantic identification;
an extraction module configured to extract road traffic semantics, so as to obtain a highly parameterized virtual road layout top view having a mapping relation with a real traffic scene;
an obtaining module configured to obtain a road layout traffic semantic grid encoding vector based on the virtual road layout top view;
a second construction module configured to construct a target coupling relation model based on influence of other targets on a target in a traffic scene;
a third construction module configured to construct a traffic force constraint model based on the target coupling relation model and a real road layout;
a trajectory prediction network construction module configured to construct a long short term memory trajectory prediction network based on the traffic force constraint model and the road layout traffic semantic grid encoding vector,
a prediction module configured to predict a motion trajectory of the target with the long short term memory trajectory prediction network, so as to obtain a predicted motion trajectory; and
a digital twinning module configured to obtain a digital twin of the scene flow based on a dynamic trajectory flow of a real target based on the trajectory extraction, the semantic identification and the predicted motion trajectory.
